(19) United States
(12) Patent Application Publication
(10) Pub. No.: US 2004/0064749 A1
(43) Pub. Date: Apr. 1, 2004

(54) Fully digitally controlled delay element with wide delay tuning range and small tuning error

(76) Inventors: Byron D. Grossnickle, Provo, UT (US); Cangsang Zhao, Portland, OR (US)

Correspondence Address: Peter Lam, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/261,533

(22) Filed: Sep. 30, 2002

(51) Int. Cl. G06F 1/12

(52) U.S. Cl. 713/400

(57) ABSTRACT

A method for a fully digitally controlled delay element with wide delay tuning range and small tuning error. The method of one embodiment comprises receiving a set of digital control bits at a delay element. The set of digital control bits is to alter the amount of delay provided from the delay element to an input signal. A driving current through a first driver of the delay element is adjusted with the digital control bits. A capacitance on an output node of the delay element is adjusted with the digital control bits. The output is a delayed version of the input signal based on the driving current and the capacitance.

### FIELD OF THE INVENTION

The present invention relates generally to the field of microprocessors and computer systems. More particularly, the present invention relates to a method and apparatus for a fully digitally controlled delay element with wide delay tuning range and small tuning error.

### BACKGROUND OF THE INVENTION

Today's integrated circuit devices involve a great deal of data communication of numerous signals over various communication buses and routing lines. Furthermore, there exists quite a bit of complexity in properly transmitting and receiving these data and control signals from one location of a chip to another. As such, different techniques are often employed to reduce signal ringing and interference, to control the signal rise time or slew rate, and to preserve signal integrity. Circuit design engineers are also working on new ways to more efficiently communicate signals across an integrated circuit die.

However, the manufacturing of integrated circuits involves extremely complex processes. In addition, the semiconductor fabrication steps can yield integrated circuit devices that do not operate exactly alike due to process skews and operating conditions. For instance, integrated circuits are often susceptible to process-voltage-temperature (PVT) variations. The generation and propagation of data signals can thus differ even on the same integrated circuit die. A circuit delay element located in one area of the die can provide a different amount of signal delay than another circuit delay element. As a result, signal communications are directly impacted by PVT variations.

Solutions to PVT variations can be helpful in the operation of integrated circuits. Some existing delay elements can be controlled to have a desired delay tuning range, but result in larger than desirable tuning errors.

### BRIEF DESCRIPTION OF THE DRAWINGS

The present invention is illustrated by way of example and not limitations in the figures of the accompanying drawings, in which like references indicate similar elements, and in which:

FIG. 1 is a block diagram of a computer system formed with a processor that includes a fully digitally controlled tunable delay element in accordance with one embodiment of the present invention;

FIG. 2 is a block diagram of a processor that includes distributed fully digitally controlled delay elements in one embodiment of the present invention;

FIG. 3 is a circuit diagram of a digitally controlled delay element that can be digitally adjusted through pass gates in accordance with a first embodiment of the present invention;

FIG. 4 is a circuit diagram of a digitally controlled delay element that can be digitally adjusted through driving current and direct capacitance adjustments in accordance with another embodiment of the present invention;

FIG. 5 is a graph of digital tuning resolutions across a tuning range for one embodiment of the present invention; and

FIG. 6 is a flow chart illustrating a method to digitally tune delay elements through a combination of current and capacitance adjustments in accordance with one embodiment of the present invention.

### DETAILED DESCRIPTION

A method and apparatus for a fully digitally controlled delay element with wide delay tuning range and small tuning error is disclosed. The embodiments described herein are described in the context of a microprocessor, but are not so limited. Although the following embodiments are described with reference to a processor, other embodiments are applicable to other types of integrated circuits and logic devices. The same techniques and teachings of the present invention can easily be applied to other types of circuits or semiconductor devices that can benefit from better signal integrity and signal characteristics impervious to process-voltage-temperature variations. The teachings of the present invention are applicable to any processor or machine that performs data signal communications. However, the present invention is not limited to processors or machines that control signal delays and can be applied to any processor and machine in which a delay element is needed.

In the following description, for purposes of explanation, numerous specific details are set forth in order to provide a thorough understanding of the present invention. One of ordinary skill in the art, however, will appreciate that these specific details are not necessary in order to practice the present invention. In other instances, well known electrical structures and circuits have not been set forth in particular detail in order to not necessarily obscure the present invention.

When integrated circuit devices are fabricated, the resulting transistors tend to behave differently depending on the particular semiconductor process and conditions. A variety of factors including, but not limited to, wafer type, process changes, losses, operating voltage, and temperature, can affect how the resultant circuitry operates. One aspect circuit designers have to deal with when working with analog circuits is the process-voltage-temperature variation (PVT). One type of circuit is a delay cell that is to provide a predetermined amount of delay. Because of PVT, the delay can vary from one die to the next. Ideally, a delay element should have approximately the amount of delay the design intended even under different process-voltage-temperature variations. Delay elements in accordance with the present invention can be insensitive to PVT when providing delay.

Accurate delay controls for generating on-die delays that are immune to PVT are desirable in integrated circuit applications. One solution for performing delay control is done by adjusting delays through delay elements. Although analog signals can be used, the distribution of analog voltage levels on a large chip is troublesome. For instance, ground bounce in the power supply network can introduce large errors to an analog voltage level, which in turn will introduce delay errors. On the other hand, distributing digital bits tends to more robust. Embodiments of the present invention utilize fully digital control signals to control delay elements to achieve wide delay adjustment ranges and very fine delay adjustment resolutions with minimal delay tuning errors comparable to analog solutions.

In order to achieve good delay tuning range and resolution, embodiments of the present invention adjust both driving current and loading capacitance. Embodiments of the present invention also use the same set of digital control bits to enact the current and capacitance adjustments to modify the tuning range, wherein if the current is adjusted to be greater, capacitance would be adjusted to be smaller. Because the current tuning resolution and the capacitance tuning resolution are inversely related, they compromise each other. In other words, the overall tuning resolution in embodiments of the present invention is based on the average of both the current and capacitive tuning. When the resolution from current tuning is low, the resolution from capacitance tuning is high, and vice versa.

For one embodiment, the delay through a delay cell is controlled with digital control signals. These control signals are coupled to manage the amount of delay by adjusting either the capacitance through the delay cell and/or the driving strength of the delay cell by changing the settings of the control signal. Thus the logic of an integrated circuit can actively monitor the amount of delay being delivered from the delay cell and change the control signals to adjust for PVT changes in order to maintain a near constant delay. Embodiments of the present invention can be used to generate process-voltage-temperature (PVT) compensated delay signal lines with accurate delay for on-die timing delay and slew rate control applications. Delay elements have also been utilized in the digital mixed design realm.

Unlike other delay elements that are controlled by only an analog voltage signals, embodiments of the present invention use fully digital signals to control and adjust delay elements. Embodiments of the present invention can be configured to achieve wide delay tuning ranges and have small delay tuning errors. Unlike other schemes that use analog control voltages that require the routing of analog signals across the die to control the delay elements, embodiments of the present invention use fully digital control signals. In a primarily digital integrated circuit device, such as a processor, the use of analog control signals could cause great headaches. Furthermore, it is not practical to send analog signals across a large die. Analog voltages for a signal tend to be at different values at different locations on a die as the generation and maintenance of an accurate analog signal is difficult. Whereas such analog control signals are highly susceptible to noise from other circuits and coupled from neighboring signals, digital control signals of the present invention are less sensitive to such concerns and are more easily sent across a die without incurring any errors. By simultaneously controlling the capacitance and current in the delay element with the same control bits, the resolution of the steps between control states is minimized and smoothed to mimic those of an analog circuit. Thus a finer tuning resolution is possible and the digitized steps between control states are less noticeable. Without the dual adjustments, the non-minimal digitized gaps that exist between different control states can have large discrete increments and make tuning more difficult. Although the control is described as simultaneous, the actual transitions and response of the drivers and capacitive structures may not be occurring at exactly the same time. The term simultaneous is more in reference to the use of the same control signals to control both adjustments.

The present embodiments still allow for very fine control of the delay tuning adjustments and can approximate the accuracy of analog techniques. The good tuning resolution of these fully digital control embodiments also allows for narrowing the delay into a small resolution window. Embodiments of the present delay cell allow for the digital control of the current and capacitance in the delay circuit with binary signals. A feedback loop provides for the monitoring of the resultant delay of the delay element and for simultaneously digitally altering the strength of the current (driver strength) and capacitance to achieve the desired delay.

In the discussion below, one embodiment in accordance with the present invention comprises a fully digitally controlled delay element formed with a set of binary weighted tri-state inverter drivers and a binary weighted capacitive load. By adjusting both the driver current/strength and the loading capacitance, a large delay tuning range can be achieved. For this embodiment, a single set of binary weighted digital control bits is used for both current and capacitance tuning. As this scheme employs primarily digital signals, the digital control bits that distributed to the delay elements are less sensitive to ground bounce and other coupling noises. The percentage tuning error that exists for the current tuning is somewhat inverse to that of the capacitive tuning. Thus the tuning of both the current and capacitance together allows for the effects of the two to compensate each other to achieve small and uniform percentage tuning errors across a full digital tuning range. Hence, this embodiment of a fully digitally adjustable delay element can use a small number of control bits to provide a large delay tuning range with close to ideal tuning error.

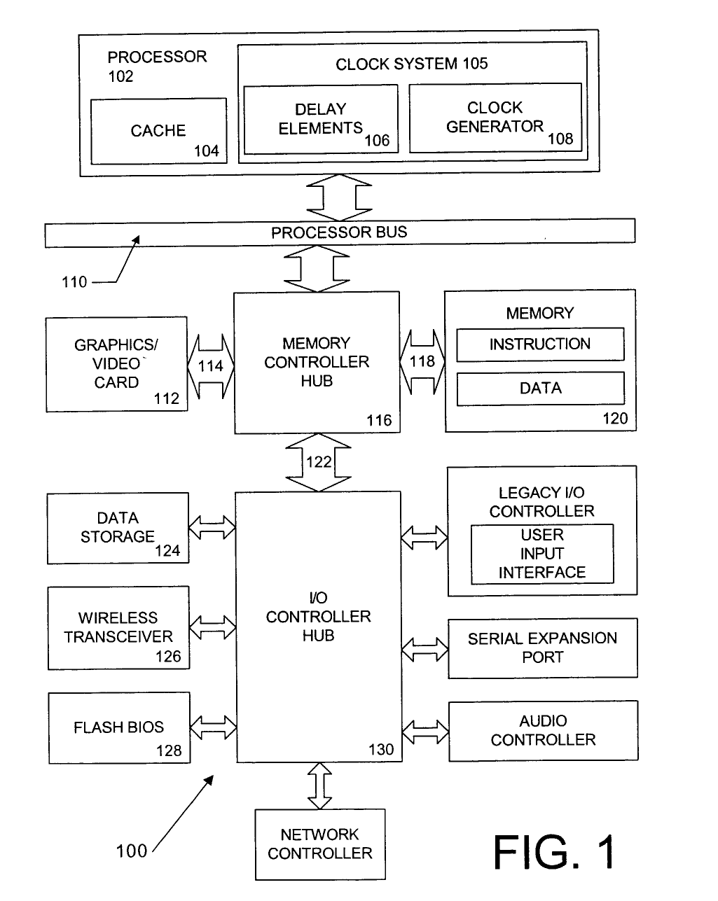

Referring now to FIG. 1, an exemplary computer system 100 is shown. System 100 includes a component, such as a processor 102 to employ fully digitally controlled delay elements 106 in accordance with the present invention, such as in the embodiment described herein. System 100 is representative of processing systems based on the PENTIUM® III, PENTIUM® 4, Itanium™, and/or XScale™ microprocessors available from Intel Corporation of Santa Clara, Calif. Other systems (including PCs having other microprocessors, engineering workstations, set-top boxes and the like) may also be used. In one embodiment, sample system 100 may execute a version of the WINDOWS™ operating system available from Microsoft Corporation of Redmond, Wash., although other operating systems like UNIX or Linux, embedded software, and/or graphical user interfaces, may also be used. Thus, the present invention is not limited to any specific combination of hardware circuitry and software.

The present enhancement is not limited to computer systems. Alternative embodiments of the present invention can be used in other devices such as handheld devices and embedded applications. Some examples of handheld devices include cellular phones, Internet Protocol devices, digital cameras, personal digital assistants (PDAs), and handheld PCs. Embedded applications can include a micro controller, a digital signal processor (DSP), system on a chip, network computers (NetPC), set-top boxes, network hubs, wide area network (WAN) switches, or any other system that communicate signals through signal lines and can benefit from adjustable delay elements.

FIG. 1 is a block diagram of a computer system 100 formed with a processor 102 that includes a clock system 105. The present embodiment is described in the context of a single processor desktop or server system, but alternative embodiments can be included in a multiprocessor system. System 100 is an example of a hub architecture. The computer system 100 includes a processor 102 to process data signals. The processor 102 can be a complex instruction set computer (CISC) microprocessor, a reduced instruction set computing (RISC) microprocessor, a very long instruction word (VLIW) microprocessor, a processor implementing a combination of instruction sets, or any other processor device, such as a digital signal processor, for example. The processor 102 is coupled to a processor bus 110 that can transmit data signals between the processor 102 and other components in the system 100. The elements of system 100 perform their conventional functions that are well known to those familiar with the art.

In one embodiment, the processor 102 includes a Level 0 (L0) internal cache memory 104 and a Level 1 (L1) internal cache memory. Depending on the architecture, the processor 102 can have a single internal cache or multiple levels of internal cache. Alternatively, in another embodiment, the cache memory can reside external to the processor 102. Other embodiments can also include a combination of both internal and external caches depending on the particular implementation and needs. Located within clock system 105 of processor 102 are a clock generator 108 and digitally controllable delay elements 106 in accordance with the present invention. For one embodiment, the digitally controllable delay elements 106 are used to delay clock signals from the clock generator 105 and to delay other signals being communicated across the die. Alternate embodiments of digitally controllable delay elements 106 can also be used in micro controllers, embedded processors, graphics devices, DSPs, memories, and other types of logic circuits and dies. System 100 includes a memory 120. Memory 120 can be a dynamic random access memory (DRAM) device, a static random access memory (SRAM) device, flash memory device, or other memory device. Memory 120 can store instructions and data represented by data signals executable by the processor 102.

A system logic chip 116 is coupled to the processor bus 110 and memory 120. The system logic chip 116 in the illustrated embodiment is a memory controller hub (MCH). The processor 102 can communicate to the MCH 116 via a processor bus 110. The MCH 116 provides a high bandwidth memory path 118 to memory 120 for instruction and data storage and for storage of graphics commands, data and textures. The MCH 116 is to direct data signals between the processor 102, memory 120, and other components in the system 100 and to bridge the data signals between processor bus 110, memory 120, and system I/O 122. In some embodiments, the system logic chip 116 can provide a graphics port for coupling to a graphics controller 112. The MCH 116 is coupled to memory 120 through a memory interface 118. The graphics card 112 is coupled to the MCH 116 through an Accelerated Graphics Port (AGP) interconnect 114.

System 100 uses a proprietary hub interface bus 122 to couple the MCH 116 to the I/O controller hub (ICH) 130. The ICH 130 provides direct connections to some I/O devices via a local I/O bus. The local I/O bus is a high-speed I/O bus for connecting peripherals to the memory 120, chipset, and processor 202. Some examples are the audio controller, firmware hub (flash BIOS) 128, wireless transceiver 126, data storage 124, legacy I/O controller containing user input and keyboard interfaces, a serial expansion port such as Universal Serial Bus (USB), and a network controller 134. The data storage device 124 can comprise a hard disk drive, a floppy disk drive, a CD-ROM device, a flash memory device, or other mass storage device.

Embodiments of the delay tuning can be used with a wide variety of signals and circuits that require reasonable delays that are not susceptible to PVT, input/output (I/O) circuits for example. Similarly, clock generators and delay lock loops can also use such a delay element to manipulate clock edges. Another embodiment can be implemented for I/O testing purposes where accurate signals are needed. For the embodiments described here, each instantiation of a delay element works with one signal and a separate copy of the delay cell is needed for each signal. Furthermore, these delay elements can be chained together to generate the desired amount of delay for that particular signal. Thus a number of delay elements can be placed at various locations on a die as needed.

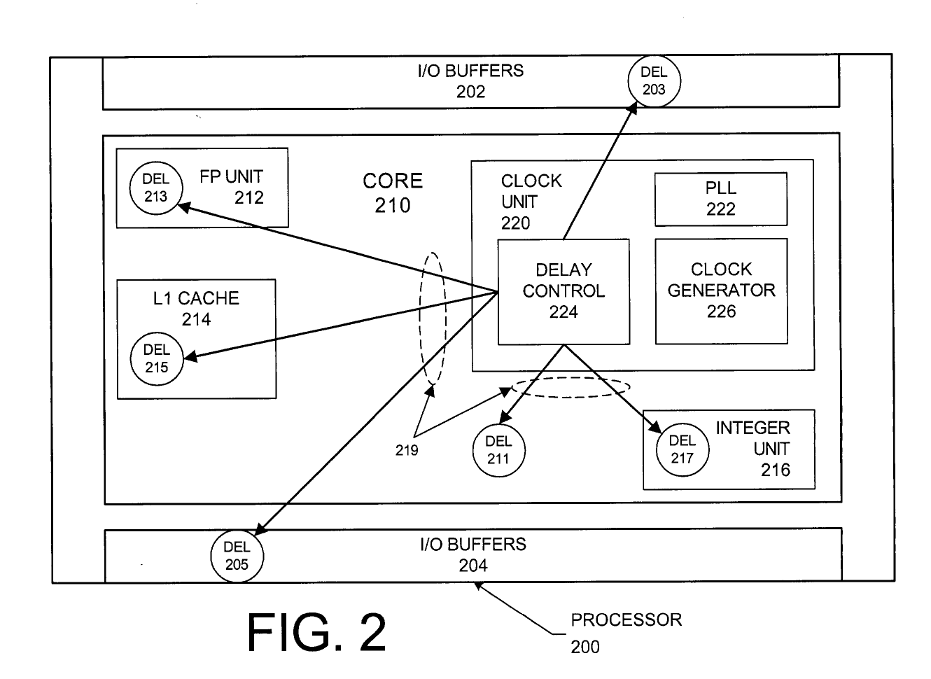

FIG. 2 is a block diagram of a processor 200 that includes an embodiment of distributed fully digitally controlled delay elements in accordance with the present invention. Embodiments of the present invention can incorporate instantiations of digitally controlled delay elements to delay signals in order to alter the timing or slew rate. These delay elements can be strategically placed at various locations such as clock circuitry 220, I/O buffers 202, 204, execution logic 212, 216, or cache memory 214. The processor floor plan of FIG. 2 shows some of the functional blocks of a single processor die. The I/O buffers 202, 204, are to handle communications between the processor die and the outside world. The processor core 210 of this example includes a floating point unit (FPU) 212, level 1 (L1) cache 214, an integer unit 216, and a clock generation unit 220. Within the clock unit 220 of this embodiment are a phase lock loop (PLL) 222, delay control 224, and a clock generator 226.

For this embodiment, a plurality of fully digitally controllable delay elements 203, 205, 211, 213, 215, 217, are distributed in the core 210 and I/O buffers 202, 204, to provide accurate timing delays and slew rate control. These delay elements can be adjusted to achieve large delay tuning ranges and small, uniform delay tuning errors. In other embodiments, the number of delay elements can vary depending on the particular implementation. Similarly, the placement of these digitally controllable delay elements are designer/application specific. In the example of FIG. 2, each of the digitally controllable delay elements 203, 205, 211, 213, 215, 217, is located proximate to the signal source which has a signal that needs tunable timing delay or adjustable slew rate. However, the delay elements can also be located anywhere along the signal routing, including the receiver. Digital control signals 219 from the delay control circuit 224 of the clock unit 220 can tune the delay elements and adjust the slew rates as needed. Multiple delay elements can also be coupled together to generate the necessary delay. For example, if each delay cell provides about 150 picoseconds of delay, ten cells can be chained together to achieve a delay of 1.5 nanoseconds.

Embodiments of the present invention may also be described with equations. For example, the delays for embodiments of delay elements in accordance to the present invention can be written as:

$$delay ( n ) ∝ \frac{{C}_{0} + {nC}_{step}}{{I}_{0} + ( 15 - n ) {I}_{step}}$$

wherein n=0, 1, 2, 3, . . . , 15 for the possible control states. I₀ is the minimum drive current through the default inverter driver, n is the digital setting, Iₛₜₑₚ is the current increment for each adjustment step, C₀ is the minimum loading capacitance, and Cₛₜₑₚ is the capacitance for each adjustment step. The maximum setting, n=15 here, implies that a 4-bit binary weighted control is used for this embodiment. Thus if a 5-bit binary weighted control were used, n would go up to 31. Furthermore, for

$${I}_{step} = \frac{{I}_{0}}{A} and {C}_{step} = \frac{{C}_{0}}{B} ,$$

the delay tuning range and tuning resolution (or tuning error) will be:

$$\begin{matrix}Delay\_tuning \_range = \frac{Delay ( 15 )}{Delay ( 0 )} = ( 1 + \frac{15}{A} ) ( 1 + \frac{15}{B} ) and \\ Delay\_tuning \_resolution ( n ) = \frac{Delay ( n + 1 ) - Delay ( n )}{Delay ( n )} \approx \frac{2 A + 15}{AB + 15 B + n ( 15 - n )} .\end{matrix}$$

I₀ and C₀ are inherent to the default state of the delay element. The amount of delay that can be achieved is a function of the current and capacitance for a given control state n. The delay is also proportional to the amount of capacitance and inversely proportional to the amount of drive current. Each upward stepping of the control bits incrementally decreases the current and incrementally increases the capacitance. When n=0, the driving strength is the greatest and the capacitance the lowest, resulting in the least delay from the delay element. When n=15, the driving strength is the smallest and the capacitance the largest, resulting in the most delay. For this embodiment, the step sizes are uniform and factors A and B are constant throughout all the steps.

A and B are constants that are defined to relate the current I and capacitance C, respectively. Note that A and B can, but do not necessarily have to be equal. The values for A and B are determined based on the particular implementation. A is the ratio of the incremental current step size and B is the ratio of the incremental capacitance step size. For one embodiment with a 4-bit control scheme where A=B=15, the tuning range is 4. In this example, the default transistor has a size of 15 and each of the parallel legs of the transistors have a size of 1. Based on

$${I}_{step} = \frac{{I}_{0}}{A} , A = 15$$

because Iₛₜₑₚ is 1/5^{th of I}₀. B is similarly defined for capacitance, but with an inverse effect. With a 5-bit binary weighted control scheme where A=B=31, the tuning error can be dramatically reduced.

The embodiments of the present invention can allow for the usage of fully digitally controlled delay elements for robust control signal distribution while still achieving good tuning range and having limited tuning error. The delay tuning range can be calculated as the maximum delay over the minimum delay. Ideally, this ratio should be as large as possible as it indicated a wider range over a process, voltage, and temperature variation. The delay tuning resolution can be calculated as the tuning error for a particular state by taking the difference between the delay of the present state and the next state over the present state delay.

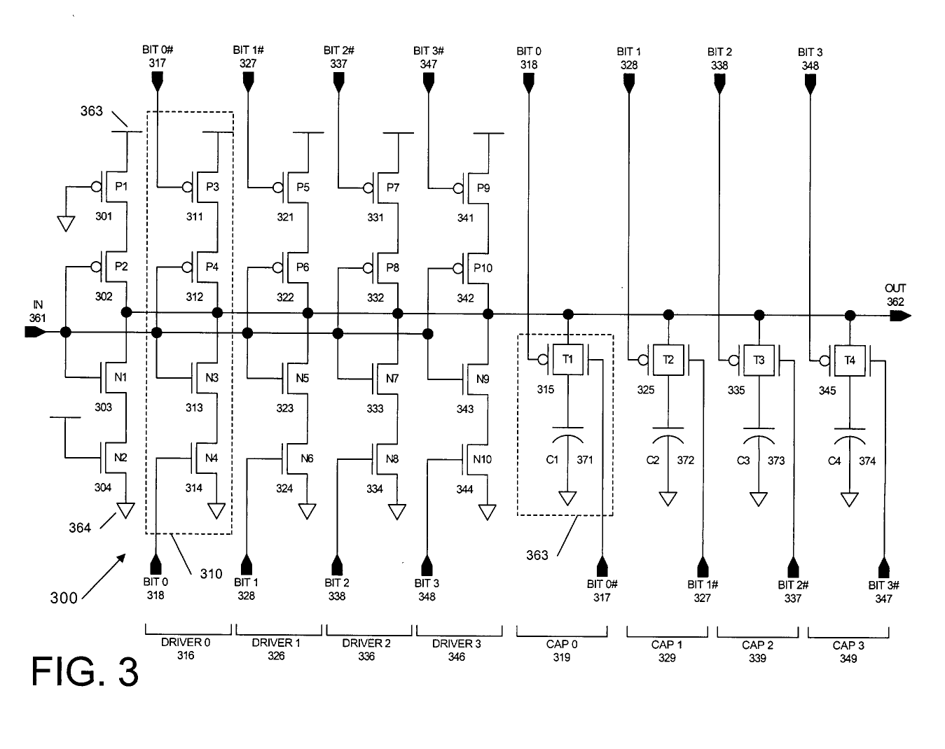

FIG. 3 is a circuit diagram of a fully digitally controlled delay element 300 that can be digitally tuned through pass gates in accordance with a first embodiment of the present invention. The delay element 300 of this embodiment is comprised of four inverting driver legs 316, 326, 336, 346, and four capacitive stages 319, 329, 339, 349. The embodiment of FIG. 3 receives an input signal IN 361 at a default inverter driver that outputs an inverted version of the input 361 at output terminal 362. The base driver is comprised of P type field effect transistors P1 301, P2 302 and N type field effect transistors N1 303, N2 304. Transistors P2 302 and N1 303 are coupled together to form an inverter structure. Transistors P1 301 and N2 304 act as resistive loads and mimic the loading and voltage drops of the drivers 316, 326, 336, 346, that are legged in the delay element. The source terminal of P1 301 is connected to a VCC supply voltage 363 and the gate terminal is connected to a ground potential 364. The drain terminal of P1 301 is connected to the source terminal of P2 302. The input signal IN 361 is connected to the gate terminals of both P2 302 and N1 303. The drains of P2 303 and N1 303 are coupled together at output node OUT 362. The source terminal of N1 303 is coupled to the drain terminal of N2 304. The gate terminal of N2 304 is coupled to supply voltage 363 and the source terminal is connected to ground 364.

The delay element of this embodiment includes four separate parallel legs of drivers 316, 326, 336, 346, that can be activated to tune the signal driving strength and current. Each leg of the drivers DRIVER 0 316, DRIVER 1 326, DRIVER 2 336, and DRIVER 3 346, are identical in size and configuration in this embodiment. For another embodiment, the sizing of the transistor devices can vary and do not need to be the same. Each of the drivers 316, 326, 336, 346, are connected together at their input terminals with the input signal 361. Similarly, all of the drivers are connected together at their output terminals at output node 362. Depending on the control signals 317, 318, 327, 328, 337, 338, 347, 348, provided to the delay element 300, different legs can be activated to drive the inverted version of node IN 361 to node OUT 362. As the drivers 316, 326, 336, 346, of FIG. 3 are identical, only the configuration 310 of DRIVER 0 316 is described with detail here for simplicity.

In the structure 310 of DRIVER 0 316, two P type transistors P3 311, P4 312, and two N type transistors N3 313, N4 314, are coupled together as a digitally controllable inverting driver. The inverter portion is formed with P4 312 and N3 313. Transistors P3 311 and N4 314 serve as control devices to enable/disable the inverter output by gating the coupling of the inverter portion to a supply voltage 363 and to ground 364. The source terminal of P3 311 is coupled to a supply voltage 363 and the gate terminal is coupled to a digital control signal BIT0# 317. BIT0# 317 is active low, as noted with the ‘#’ symbol in the signal name, meaning the P type device P3 311 is turned on to conduct current when BIT0# 317 is a logic low. When BIT0# 317 is a logic high, P3 311 is off. The drain terminal of P3 311 is connected to the source terminal of P4 312. The gate terminals of P4 312 and N3 313 are connected together at input node IN 361. The drain terminals of P4 312 and N3 313 are connected together at output node OUT 362. The source terminal of N3 313 is connected to the drain terminal of N4 314.

The source terminal of N4 314 is coupled to ground 364 and the gate terminal is coupled to a digital control signal BIT0 318. BIT0 318 is active high, meaning the N type device N4 314 is turned on to conduct current when BIT0 318 is a logic high and N4 314 is off when BIT0 318 is a logic low. BIT0 318 and BIT0# 317 are complementary wherein BIT0 318 is high when BIT0# 317 is low and vice versa. Thus when BIT0 318 and BIT0# 317 are enabled, N4 314 and P3 311, respectively, are turned on to pass current through the inverter. When BIT0 318 and BIT0# 317 are off, N4 314 and P3 311 are off, causing the inverter and driver to be disabled from driving a signal on OUT 362.

In the other identical driver legs, the drivers 326, 336, 346, are constructed similarly. Each leg can be enabled with the respective pair of control signals. DRIVER 1 326 is digitally controlled with the signals BIT1 328 and BIT1# 327 that are coupled to N6 324 and P5 321, respectively. DRIVER 2 336 is digitally controlled with signals BIT2 338 and BIT2# 337, respectively. DRIVER 3 346 is digitally controlled with signals BIT3 348 and BIT3# 347, respectively.

Also coupled to the output terminal OUT 362 of the delay element circuit 300 are parallel capacitive structures 319, 329, 339, 349. For this embodiment, the capacitance adjustments are made through pass gates. These pass gates 315, 325, 335, 345, allow the inverter drivers 316, 326, 336, 346, see more or less current. Each capacitive structure CAP 0 319, CAP 1 329, CAP 2 339 CAP 3 349, of this embodiment is constructed from a transmission gate that can couple the output node OUT 362 to a capacitor depending on control signals. For instance, the arrangement 363 of CAP 0 319 is comprised of a transmission gate 315 having a P type transistor and an N type transistor coupled together with a capacitor C1 371. The source terminal of the P device is connected together with the drain terminal of the N device at node OUT 362. The drain terminal of the P device is connected together with the source terminal of the N device at a first terminal of C1 371. The second terminal of C1 371 is connected to ground 364. The gate terminal of the P device is connected to active high control signal BIT0 318 and the gate terminal of the N device is connected to the complementary active low control signal BIT0# 317. Thus when BIT0 318 and BIT0# 317 are active, the transmission device T1 315 is enabled to couple node OUT 362 to C1 371 to add capacitance. But when BIT0 318 and BIT0# 317 are off, T1 315 serves as disconnect C1 371 from the output node OUT 362.

Capacitive structures CAP 1 329, CAP 2 339, and CAP 3 349 are similarly configured and also coupled to node OUT 362. CAP 1 329 is controlled by digital signals BIT1 328 and BIT1# 327. CAP 2 339 is controlled with digital control signals BIT2 338 and BIT2# 337. CAP 3 349 is controlled with control signals BIT3 348 and BIT3# 347. Based on the particular settings of the control signals 317, 318, 327, 328, 337, 338, 347, 348, various levels of capacitance can be coupled to node OUT 362 as different combinations of the capacitors C1 371, C2 372, C3 373, C4 374, are coupled/decoupled by turning on or off the transmission devices 315, 325, 335, 345.

The four pairs of control signals of FIG. 3 allow for fifteen control states and one default off state. Thus the drivers and capacitances can be configured to adjust the current and capacitances to fifteen individual steps. Because the same four digital control signals are used on both the drivers and capacitive structures, the current and capacitance are both adjusted such that when driving strength is being reduced, capacitive load is increased, and vice versa. So when all the control bits are on, the strongest driver strength will drive a minimum effective capacitance.

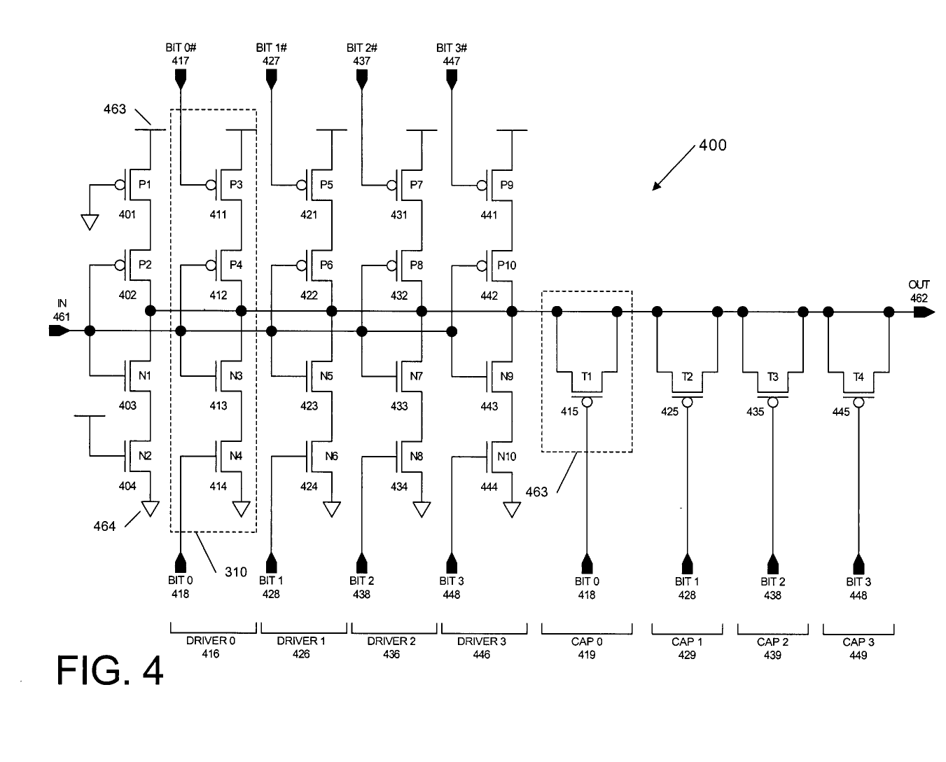

FIG. 4 is a circuit diagram of a digitally controlled delay element 400 that can be digitally adjusted through driving current and direct capacitance adjustments in accordance with another embodiment of the present invention. The capacitive loads for this embodiment of a delay cell are manipulated differently from those of FIG. 3 to generate better tuning error and to obtain larger variation ranges. For this embodiment of a delay element 400, the four parallel drivers (DRIVER 0 416, DRIVER 1 426, DRIVER 2 436, DRIVER 3 446) and four parallel capacitances (CAP 0 419, CAP 1 429, CAP 2 439, CAP 3 449) are also legged as four individually controllable driver/capacitance pairs. For example, the BIT0 418 and BIT0# 417 control signals can activate/deactivate DRIVER 0 416 and CAP 0 419 as a set. Similarly, DRIVER 1 426 and CAP 1 429 are controlled with digital control signals BIT1 426 and BIT1# 427. DRIVER 2 436 and CAP 2 439 are controlled by control signals BIT2 436 and BIT2# 437. Control signals BIT3 446 and BIT3# 447 can enable/disable DRIVER 3 446 and CAP 3 449. Each control signal and its ‘#’ counterpart are complementary in nature.

The delay element circuit 400 of this embodiment receives an input signal IN 461 at a default inverter driver that outputs an inverted version of the input 461 at output terminal OUT 462. The base driver is comprised of P type transistors P1 401, P2 402, and N type transistors N1 403, N2 404. P2 402 and N1 403 are coupled together to form an inverter structure. P1 301 and N2 304 act as resistive loads and mimic the loading and voltage drops of the legged drivers 416, 426, 436, 446. The source terminal of P1 401 is connected to a VCC supply voltage 463 and the gate terminal is connected to a ground potential 464. The drain terminal of P1 401 is connected to the source terminal of P2 402. The input signal IN 461 is connected to the gate terminals of both P2 402 and N1 403. The drains of P2 403 and N1 403 are coupled together at node OUT 462. The source terminal of N1 403 is coupled to the drain terminal of N2 404. The gate terminal of N2 404 is coupled to supply voltage 463 and the source terminal is connected to ground 464.

Although the drivers and capacitors for the four individually controllable driver/capacitance pairs of this embodiment have identical configurations, other embodiments are not limited as such and different circuit arrangements are possible depending on the particular implementation and design. Furthermore, the sizing of the various transistors and capacitors can vary. In one embodiment, the drivers can have similarly sized transistors. For another embodiment, the transistor devices in the drivers can be sized such that each driver can provide a different drive strength. Similarly, capacitive elements may or may not be sized identically depending on whether the each of the elements are configured to provide equal amounts of capacitance or whether differing amounts of capacitance are desired from each capacitive element.

Each of the drivers 416, 426, 436, 446, are connected together at their input terminals with the input signal 461. Similarly, all of the drivers are connected together at their output terminals at output node 462. Depending on the control signals 417, 418, 427, 428, 437, 438, 447, 448, provided to the delay element 400, different legs can be activated to drive the inverted version of node IN 461 to node OUT 462. For this embodiment, each driver is comprised of two P type devices and two N type devices coupled together as a digitally controlled inverting driver. The inverter portions of each leg 416, 426, 436, 446, are formed with transistor pairs P4 412 and N3 413, P6 422 and N5 423, P8 432 and N7 433, and P10 442 and N9 443, respectively. Transistor pairs P3 411 and N4 414, P5 421 and N6 424, P7 431 and N8 434, and P9 441 and N10 444, serve as control devices for each driver leg 416, 426, 436, 446, respectively, to enable/disable the inverter output by coupling/decoupling the respective inverter portion to and from a supply voltage 462 and ground 463. The source terminal for each of P3 411, P5 421, P7 431, and P9 441 is coupled to a supply voltage 463 and the gate terminal of each is coupled to a digital control signal BIT0# 417, BIT1# 427, BIT2# 437, BIT3# 447, respectively. The drain terminal of P3 411, P5 421, P7 431, P9 441, is connected to the source terminal of P4 412, P6 422, P8 432, P10 442, respectively. The gate terminals of P4 412, N3 413, P6 422, N5 423, P8 432, N7 433, P10 442, and N9 443 are all connected to input node IN 461. The drain terminals of P4 412, N3 413, P6 422, N5 423, P8 432, N7 433, P10 442, and N9 443 are connected to output node OUT 462. The source terminal of N3 413, N5 423, N7 433, N9 443, is connected to the drain terminal of N4 414, N6 424, N8 434, N10 444, respectively. The source terminal for each of N4 414, N6 424, N8 434, and N10 444 is coupled to ground 464 and the gate terminal of each is coupled to a digital control signal BIT0 418, BIT1 428, BIT2 438, BIT3 448, respectively. As different combinations of the digital control signals are sent to the delay element 400, the selected drivers 416, 426, 436, 446, are enabled/disabled as appropriate.

For this embodiment, the capacitances are directly adjusted. Each of the capacitors CAP 0 419, CAP 1 429, CAP 2 439, CAP 3 449, are connected to output node OUT 462 to assist with signal stability. The capacitors for this embodiment are actually P type field effect transistors T1 415, T2 425, T3 435, T4 445, wherein both the drain and source terminals are coupled to node OUT 462. BIT0 418 is coupled to the gate terminal of T1 415 to control whether CAP 0 419 provides capacitance to node OUT 462 or not. BIT1 428 is coupled to the gate terminal of T2 425 to control whether CAP 1 429 provides capacitance to node OUT 462 or not. BIT2 438 is coupled to the gate terminal of T3 435 to control whether CAP 2 439 provides capacitance to node OUT 462 or not. BIT3 448 is coupled to the gate terminal of T4 445 to control whether CAP 3 449 provides capacitance to node OUT 462 or not.

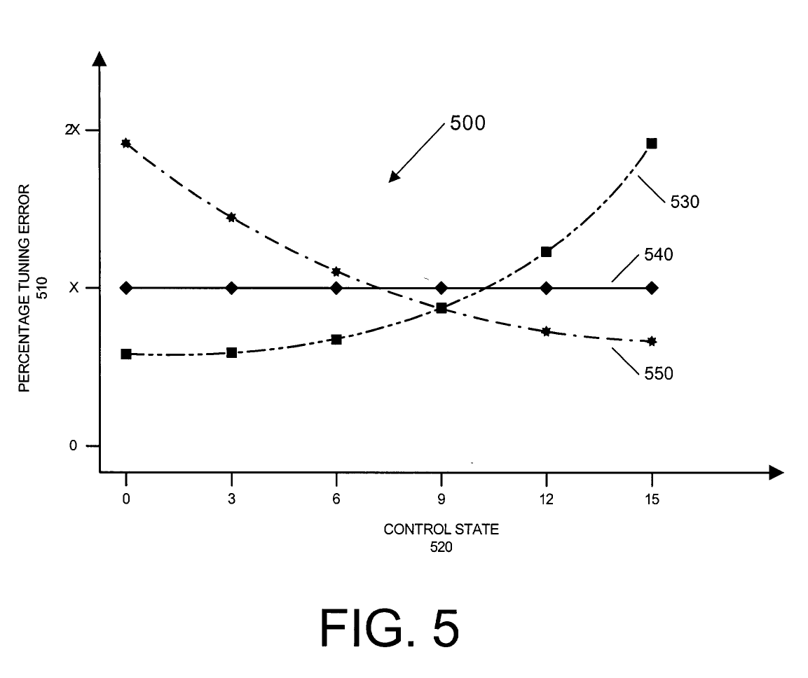

FIG. 5 is a graph 500 of digital tuning resolutions across a tuning range for one embodiment of the present invention. This graph 500 plots the percentage tuning error 510 across the various control states 520. Line 540 represents the ideal percentage tuning error across 15 control for one embodiment. As shown by line 540, the percentage tuning error is fairly consistent across the control states, thus providing consistent and predictable delay. Embodiments of delay elements such as the ones described above in FIGS. 3 and 4 can approximate this ideal percentage tuning error and approach the performance available with analog delay cells. Line 530 illustrates the percentage tuning error for a circuit that only performs current adjustments, and not capacitance adjustments. As shown by line 530, the percentage tuning error increases from control state to control state 15. Thus the a current adjustment only circuit can introduce varying degrees of error due to inconsistent delays. Line 550 illustrates the percentage tuning error for a circuit that only performs capacitance adjustments, and not current adjustments. As shown by line 550, the percentage tuning error decreases from control state to control state 15. Thus the a capacitance adjustment only circuit can also introduce varying degrees of error due to inconsistent delays.

For the example desired results on line 540 of this graph, the delay elements are adjusted using four digital to simultaneously control the current and capacitance. As the control digits are increased to increase the drive strength in order to reduce the delay, the capacitance is decreased. With four binary bits, fifteen control states are possible. However, different numbers of control states are possible depending on the particular implementation. Finer tuning and manipulation of the tuning error can be possible with increasing the number of control states and current/capacitance stages. As the number of control bits and control states increases, accuracy and tuning range can be increased while the percentage tuning error can decrease. Generally, it is desirable to minimize the percentage tuning error. Similarly, a uniform tuning error across all the allowable states can be desirable. In FIG. 5, the ideal percentage tuning error represented a desired minimal amount of error because a 0% error may not be realistic. This is simply due to the inherent nature of using digital adjustments. The steps between the control states are digitized and depending on the granularity of the system, the steps can be large or small.

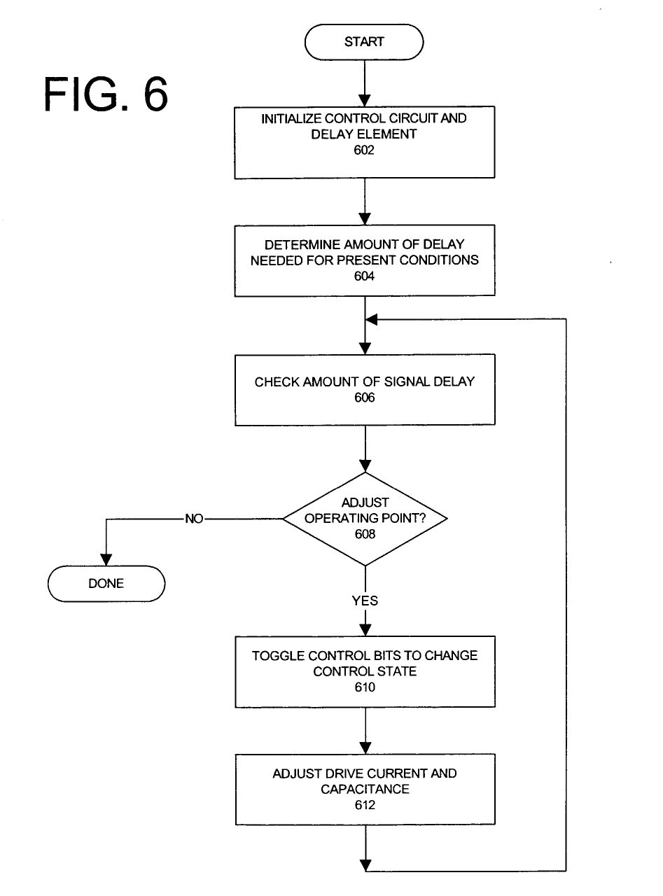

FIG. 6 is a flow chart illustrating a method to digitally tune delay elements through a combination of current and capacitance adjustments in accordance with one embodiment of the present invention. At block 602, a delay element and the control circuit to control the delay element are initialized. For most embodiments, this initialization occurs with the overall startup process of the integrated circuit device. The control circuit determines the amount of delay needed for the present conditions based on process, voltage, and temperature variations at block 604. As the PVT variations can also vary from one region of the chip to another, in this embodiment, this determination is done for each signal coupled to a digitally controlled delay element. At block 606, the output terminal of a delay element is checked as to the amount of signal delay available for the input signal to that delay circuit. A determination is made at block 608 as to whether the operating point of the delay element needs to be modified. If the amount of delay provided by the delay circuit is within acceptable levels of that needed, the operation of the delay element does not have to be adjusted and the configuration is done. However, if the amount of delay provided by the delay circuit is different from that level delay needed for that signal, the control logic proceeds to modify the operation of the delay element. At block 610, the control logic toggles the digital control bits to change the control state to one that should provide the desired amount of delay. The delay circuit responds to the control bits at block 612 and adjusts the driving current and capacitance accordingly. Embodiments in accordance with the present invention use a single set of digital control bits that control and adjust both the driving current and capacitance for the delay element. The drivers and capacitors are controlled together to achieve the target delay. As the driving current and capacitive load changes, the delay through the delay element increases or decreases depending on which drivers and capacitors are enabled. For the method of this embodiment, it loops back to block 606 to conduct another check of the signal delay versus the needed delay. If the needed delay has not been reached, another adjustment is made.

In the foregoing specification, the invention has been described with reference to specific exemplary embodiments thereof. It will, however, be evident that various modifications and changes may be made thereof without departing from the broader spirit and scope of the invention as set forth in the appended claims. The specification and drawings are, accordingly, to be regarded in an illustrative rather than a restrictive sense.

What is claimed is:

1. A method comprising:
receiving a set of digital control bits at a delay element, said set of digital control bits to alter amount of delay provided from said delay element to an input signal;
adjusting a driving current through a first driver of said delay element with said digital control bits;
adjusting a capacitance on an output node of said delay element with said digital control bits; and
outputting a delayed version of said input signal based on said driving current and said capacitance.

2. The method of claim 1 further comprising generating said set of digital control bits at control logic, said digital control bits to indicate a first control state.

3. The method of claim 2 wherein said set of digital control bits comprise of four binary weighted bits, said four binary weighted bits to allow for sixteen control states.

4. The method of claim 3 wherein each of said sixteen control states is to set an adjustable driving current to predefined amount and to set an adjustable capacitance to a predefined amount.

5. The method of claim 4 wherein said set of digital control bits adjusts said driving current and said capacitance together in an inverse manner, wherein said driving current is to be increased if said capacitance is to be decreased and said driving current is to be decreased if said capacitance is to be increased.

6. The method of claim 5 wherein each of said sixteen control states differs from an adjacent control state by a driving current step and a capacitance step, wherein said driving current step is an incremental amount of change in said driving current between one control state and a next control state, and wherein said capacitance step is an incremental amount of change in said capacitance between said one control state and said next control state.

7. The method of claim 6 wherein said amount of delay is adjusted to account for process, voltage, or temperature variations on an integrated circuit.

8. An apparatus comprising:
a default driver to communicate an input signal to an output signal;
a first and a second digitally controlled drivers that can be enabled and disabled with digital control signals, said first and second digitally controlled drivers coupled in parallel with said default driver to receive said input signal and to output said output signal;
a first and a second digitally controlled capacitances that can be digitally enabled and disabled to couple and decouple from said output signal; and
a set of inputs to receive a set of digital control bits to control both said first and second digitally controlled drivers and said first and second digitally controlled capacitances.

9. The apparatus of claim 8 wherein said set of digital control bits are to define a plurality of control states.

10. The apparatus of claim 9 wherein if a control state is to decrease an amount of delay between said input signal and said output signal, said digital control bits are to enable at least one of said digitally controlled drivers to increase a driving current through said digitally controlled drivers and to disable at least one of said digitally controlled capacitances to decrease a capacitive load on said output signal.

11. The apparatus of claim 9 wherein if a control state is to increase an amount of delay between said input signal and said output signal, said digital control bits are to disable at least one of said digitally controlled drivers to decrease a driving current through said digitally controlled drivers and to enable at least one of said digitally controlled capacitances to increase a capacitive load on said output signal.

12. The apparatus of claim 9 wherein said set of digital control bits are to control said first and second digitally controlled drivers and said first and second digitally controlled capacitances together.

13. The apparatus of claim 12 wherein said set of digital control bits comprises of four binary bits, said four binary bits to define sixteen possible control states.

14. The apparatus of claim 13 wherein an amount of driving current and capacitance differs between each adjacent control states by a driving current step and a capacitance step.

15. A system comprising:
a control logic to generate a set of digital control bits to indicate different control states;
a delay element coupled to receive said set of digital control bits, said delay element to provide a delay to an input signal wherein an output of said delay element is a delayed version of said input signal, said delay element to adjust an amount of said delay based on said set of digital control bits, wherein said set of digital control bits adjust both a driving current and an capacitive load in order to increase and decrease said delay.

16. The system of claim 15 wherein said delay element is comprised of:
a default driver to communicate said input signal to an output signal;
a first and a second digitally controlled drivers that can be enabled and disabled with digital control signals, said first and second digitally controlled drivers coupled in parallel with said default driver to receive said input signal and to output said output signal;
a first and a second digitally controlled capacitances that can be digitally enabled and disabled to couple and decouple capacitance from said output signal; and
a set inputs to receive said set of digital control bits to control both said first and second digitally controlled drivers and said first and second digitally controlled capacitances.

17. The system of claim 16 wherein if said set of control bits is configured to decrease an amount of delay between said input signal and said output signal, said digital control bits are to enable at least one of said digitally controlled drivers to increase a driving current through said digitally controlled drivers and to disable at least one of said digitally controlled capacitances to decrease a capacitive load on said output signal.

18. The system of claim 16 wherein if said set of control state is configured to decrease an amount of delay between said input signal and said output signal, said digital control bits are to enable at least one of said digitally controlled drivers to increase a driving current through said digitally controlled drivers and to disable at least one of said digitally controlled capacitances to decrease a capacitive load on said output signal.

19. The system of claim 16 wherein said set of digital control bits are to define a plurality of control states wherein each control state differs from its adjacent control state by a predefined driving current amount and a predefined capacitance value.

20. The system of claim 19 wherein said set of digital control bits can be manipulated to adjust said driving current and said capacitive load by a multiple of said predefined driving current and a multiple of said predefined capacitance value, respectively, to achieve a desired delay from said delay element.

21. The system of claim 20 wherein said delay element is coupled to in input/output signal for an integrated circuit device.

22. A method comprising:
detecting process, voltage, and temperature variations for a circuit;
manipulating a set of digital control bits in response to said variations;
communicating said set of digital control bits to a delay circuit, said delay circuit to provide delay to a signal, wherein said delay circuit is to receive an input signal and to output a delayed version of said input signal as its output signal; and
adjusting both a driving current and a capacitance for said delay circuit based on said set of digital control bits, wherein said set of digital control bits is to control a plurality of drivers and an plurality of capacitances in said delay circuit.

23. The method of claim 22 wherein said set of digital control bits adjusts said driving current and said capacitance together in an inverse manner, wherein said driving current is to be increased if said capacitance is to be decreased and said driving current is to be decreased if said capacitance is to be increased.

24. The method of claim 23 wherein said set of digital control bits represent a set of control states, wherein each control state differs from its adjacent control state by a predefined driving current amount and a predefined capacitance value.

25. The method of claim 24 wherein said set of digital control bits can be manipulated to adjust said driving current and said capacitive load by a multiple of said predefined driving current and a multiple of said predefined capacitance value, respectively, to achieve a desired delay from said delay element.
